(19) United States
(12) Patent Application Publication
(10) Pub. No.: US 2025/0299530 A1
(43) Pub. Date: Sep. 25, 2025

(54) ONLINE GAMING PLATFORM USING DYNAMIC CONTENT AND REAL-TIME PERSONALIZATION

(71) Applicant: WagerWheel LLC, Park Ridge, IL (US)

(72) Inventor: Nicholas R. Corlett, Park Ridge, IL (US)

(21) Appl. No.: 18/973,602

(22) Filed: Dec. 9, 2024

Related U.S. Application Data
(63) Continuation of application No. 18/381,375, filed on Oct. 18, 2023, now abandoned.
(60) Provisional application No. 63/380,363, filed on Oct. 20, 2022.

(51) Int. Cl. G07F 17/32

(52) U.S. Cl. CPC G07F 17/323; G07F 17/3209; G07F 17/3211; G07F 17/3262; G07F 17/3288

(57) ABSTRACT

An online gaming platform uses a random number generator implementing a machine learning algorithm with dynamic content and real-time personalization. The online gaming platform comprises a display device, a touch screen input, and a processor coupled to the display device and the touch screen input. The display device displays the dynamic content associated with wagers related to live sporting events. A graphical user interface (GUI) on the display device includes first and second wager inputs. The first wager input includes a selection of a wager team, a wager line, and a wager odds from the wager data. The second wager input includes a wagering amount. The GUI on the display device displays a first spinning wheel indicating a plurality of line adjustments and a second spinning wheel comprising a plurality of odds adjustments to the first water inputs and/or the second wager inputs generated by the random number generator.

### CROSS-REFERENCE TO RELATED APPLICATIONS

This application claims priority to U.S. patent application Ser. No. 18/381,375, filed Oct. 18, 2023, which claims priority to U.S. Provisional Application No. 63/380,363, filed Oct. 20, 2022, all of which are herein incorporated by reference in their entirety.

### FIELD

Aspects of the disclosure generally relate to methods and computer systems, including one or more computers particularly configured and/or executing computer software. More specifically, aspects of this disclosure relate to a casino/sports-betting gaming system with methods and systems for a casino game/add-on used for sports betting. Technical field: Sports betting, casino games, casino promotions, casino bonuses, odds boosters.

### BACKGROUND

Sports betting is a very crowded market. Sportsbook operators are constantly trying to differentiate themselves. Sports betting is a never-ending cycle of spending money in order for sportsbook operators to continue making their products better. This perennial issue damages bottom line profits and costs sportsbook operators a lot of money to acquire, retain, and reactivate new and existing users.

There are various problems for bettors and their betting experience. For example, with straight bets (like propositions), bettors and users are limited to booked odds. This limitation can lead to limited excitement for the bettor as they are going to have to risk a lot to win a lot, or decrease their odds (such as betting on an underdog). The various problems for bettors may include, but not be limited to: limited betting options, limited “unique” betting options for bettors, and limited volatility on straight bets, resulting in placing of parlays.

Additionally, there are various problems for sportsbook operators. The various problems the sportsbook operators might include, but not be limited to: low and/or narrow profit margins; risk management can be difficult and operators must balance offering attractive odds for bettors but mitigating risk of potential losses; limited ability to retain, reactivate, and attract bettors and users; and a competitive/saturated market. Operators face many challenges in attracting and retaining users, as this is a highly competitive industry.

Traditional betting can get repetitive and sportsbook operators will have to constantly offer superior products to acquire bettors (as seen in new mobile application upgrades, features, and enticing promotions). Sportsbook operators are also constantly seeking new innovations and new promotions to attract users, keeping them engaged, and keeping them coming back for business. Additionally, sportsbook operators are also constantly trying to provide competitive odds in both retail and online casinos/sportsbooks.

Traditional odds boosters are used as promotions, and customer acquisition. Odds boosters are a promotion that operators use which boosts the odds in favor of the bettor. Simply put—odds boosters are regular bets offered at enticing odds. The sportsbook operator will give up some or most of the “vig” for these boosted wagers, sometimes forcing the operator to forgo their house edge. “Vig,” or vigorish, is the cut or amount charged by a sportsbook for taking a bet, also known as juice in slang terms. The sportsbook operator only collects the vig if the bettor loses the wager.

Odds boost promotions are oftentimes limited to specific games, sports, or bet types, which gives bettors a limited number of options. Sportsbook operators use odds boosters as a tool to highlight specific games that entices the user with boosted odds on an event they may or may not be interested in. Traditional odds boosters tend to be used on straight bets.

Volatility in sports betting relies on two variables: stake and odds. With straight bets, in order for a bettor to win a significant amount of money, a bettor can either risk a lot of money on a favorite (higher stake) or bet on an underdog (higher odds). Therefore, odds boosters are successful ways of attracting new and existing users. With traditional odds boosters, sportsbook operators may forgo house edge to attract users. Sportsbook operators may even be taken advantage of due to the price disparities of highly boosted odds. Since sportsbook operators may give up some vig, these promotions cannot be used often as they are not always profitable for the sportsbook operator. The solution?Allowing users to spin a wheel(s) for a chance to boost their odds using a novel casino/sports-betting gaming system. The wheel included with the casino/sports-betting gaming system may not be proportional, so the casino/sports-betting gaming system may allow sportsbook operators to offer users the chance at boosted odds for any bet type and any event without giving up their house edge.

### SUMMARY

The following presents a simplified summary of the disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

Aspects of this disclosure pertain to a technology-enabled casino/sports-betting gaming system with methods and systems for a casino game/add-on used for sports betting.

For example, in one embodiment, a gaming device may comprise: a display device; a touch screen input; a processor connected to the display device and the touch screen input; and a memory coupled to the processor, the memory comprising machine-readable instructions.

The machine-readable instructions, when executed by the processor, may cause the processor to: receive, from a data storage device, wager data corresponding to a plurality of events, betting lines, and wagers; generate a graphical user interface (GUI) on the display device that receives an input that corresponds to a wager, wherein the input comprises a first wager input and a second wager input corresponding to the wager data; receive, via the GUI, the first wager input that selects a wager team, a wager line, and a wager odds from the wager data; after receiving the first wager input, receive, via the GUI, the second wager input that selects a wagering amount; after receiving the second wager input, receive, via the GUI, an odds booster input that corresponds to an odds booster game for the wager team, the wager line, the wager odds, and the wagering amount, wherein the odds booster game changes the wager line and the wager odds, wherein the odds booster game includes a random number generator executing within the processor that includes one or more of a line adjustment graphic and an odds adjustment graphic; generate the line adjustment graphic on the GUI, via the random number generator executing within the processor; calculate and adjust, via the random number generator executing within the processor, an adjusted wager line using the line adjustment graphic; generate the odds adjustment graphic on the GUI, via the random number generator executing within the processor; calculate and adjust, via the random number generator executing within the processor, an adjusted wager odds using the odds adjustment graphic; display, via the GUI, final wager data that includes the wager team, the adjusted wager line, the adjusted wager odds, and the wagering amount; and send, via a communication interface and to the data storage device, the final wager data corresponding to the wager team, the adjusted wager line, the adjusted wager odds, and the wagering amount.

Additionally, the line adjustment graphic may include a line differential wheel that includes a plurality of line adjustments as calculated by the random number generator executing within the processor. The plurality of line adjustments may include one or more positive line adjustments and one or more negative line adjustments. The odds adjustment graphic may include an odds wheel that includes a plurality of odds adjustments as calculated by the random number generator executing within the processor. The plurality of odds adjustments may include one or more positive odds adjustments and one or more negative odds adjustments. The wager data may comprise a home/away indication and event time/date information. The display device, the touch screen input, and the processor may be included within a mobile device. The gaming device may further include a gaming terminal with a housing that encloses the display device, the touch screen input, and the processor.

In another embodiment, a computer-implemented method for a casino/sports-betting gaming system with an odds booster game may comprise one or more of the following steps: receiving, from a data storage device, wager data corresponding to a plurality of events, betting lines, and wagers; generating a graphical user interface (GUI) on a display device that receives an input that corresponds to a wager, wherein the input comprises a first wager input and a second wager input corresponding to the wager data; receiving, via the GUI, the first wager input that selects a wager team, a wager line, and a wager odds from the wager data; after receiving the first wager input, receiving, via the GUI, the second wager input that selects a wagering amount; after receiving the second wager input, receiving, via the GUI, an odds booster input that corresponds to an odds booster game for the wager team, the wager line, the wager odds, and the wagering amount, wherein the odds booster game changes the wager line and the wager odds, wherein the odds booster game includes a random number generator operating within a machine learning algorithm and executing within a processor that includes one or more of a line adjustment graphic and an odds adjustment graphic; generating the line adjustment graphic on the GUI, via the random number generator operating within the machine learning algorithm executing within the processor; calculating and adjusting, via the random number generator operating within the machine learning algorithm executing within the processor, an adjusted wager line using the line adjustment graphic; generating the odds adjustment graphic on the GUI, via the random number generator operating within the machine learning algorithm executing within the processor; calculating and adjusting, via the random number generator operating within the machine learning algorithm executing within the processor, an adjusted wager odds using the odds adjustment graphic; displaying, via the GUI, final wager data that includes the wager team, the adjusted wager line, the adjusted wager odds, and the wagering amount; and sending, via a communication interface and to the data storage device, the final wager data corresponding to the wager team, the adjusted wager line, the adjusted wager odds, and the wagering amount.

In yet another embodiment, a system for an odds booster game may comprise a processor and a memory coupled to the processor, the memory comprising machine-readable instructions. The machine-readable instructions, when executed by the processor, may cause the processor to: receive, from a data storage device, wager data corresponding to a plurality of events, betting lines, and wagers; generate a graphical user interface (GUI) on a display device that receives an input that corresponds to a wager, wherein the input comprises a first wager input and a second wager input corresponding to the wager data; receive, via the GUI, the first wager input that selects a wager team, a wager line, and a wager odds from the wager data; after receiving the first wager input, receive, via the GUI, the second wager input that selects a wagering amount; after receiving the second wager input, receive, via the GUI, an odds booster input that corresponds to an odds booster game for the wager team, the wager line, the wager odds, and the wagering amount, wherein the odds booster game changes the wager line and the wager odds, wherein the odds booster game includes a random number generator operating within a machine learning algorithm and executing within the processor that includes one or more of a line adjustment graphic and an odds adjustment graphic; generate, calculate, and adjust, via the random number generator operating within the machine learning algorithm executing within the processor, an adjusted wager line using a line adjustment graphic; generate, calculate, and adjust, via the random number generator operating within the machine learning algorithm executing within the processor, an adjusted wager odds using an odds adjustment graphic; display, via the GUI, final wager data that includes the wager team, the adjusted wager line, the adjusted wager odds, and the wagering amount; and send, via a communication interface and to the data storage device, the final wager data corresponding to the wager team, the adjusted wager line, the adjusted wager odds, and the wagering amount.

These as well as other novel advantages, details, embodiments, features and objects of the present disclosure will be apparent to those skilled in the art from following the detailed description of the disclosure, the attached claims and accompanying drawings, listed herein, which are useful in explaining the disclosure.

### BRIEF DESCRIPTION OF THE DRAWINGS

A more complete understanding of the present disclosure and the advantages thereof may be acquired by referring to the following description in consideration of the accompanying drawings, in which like reference numbers indicate like features, and wherein:

FIG. 1 shows a schematic block diagram that illustrates various components of a computing device, which may embody or be included as part of the devices, systems, and/or methods used with a casino/sports-betting gaming system in accordance with aspects of this invention.

FIGS. 2A-2H illustrates an exemplary embodiment of a casino/sports-betting gaming system in accordance with aspects of this invention.

FIGS. 3A and 3B illustrate an additional embodiment of the casino/sports-betting gaming system from FIGS. 2A-2H in accordance with aspects of this invention.

FIGS. 4A and 4B illustrate an additional embodiment of the casino/sports-betting gaming system from FIGS. 2A-2H in accordance with aspects of this invention.

FIGS. 5A and 5B illustrates another exemplary embodiment of another casino/sports-betting gaming system in accordance with aspects of this invention.

FIG. 6 illustrates another exemplary embodiment of another casino/sports-betting gaming system in accordance with aspects of this invention.

FIG. 7 illustrates another exemplary embodiment of another casino/sports-betting gaming system in accordance with aspects of this invention.

FIG. 8 illustrates another exemplary embodiment of another casino/sports-betting gaming system in accordance with aspects of this invention.

FIG. 9 depicts a schematic block diagram that illustrates a dedicated gaming terminal using a casino/sports-betting gaming system in accordance with aspects of this invention.

FIGS. 10A and 10B depict a flowchart illustrating operations of systems/methods according to some embodiments of a casino/sports-betting gaming system in accordance with aspects of this invention.

### DETAILED DESCRIPTION

In the following description of the various examples, reference is made to the accompanying drawings, which form a part hereof, and in which is shown by way of illustration various examples in which aspects may be practiced. References to “embodiment,” “example,” and the like indicate that the embodiment(s) or example(s) of the disclosure so described may include particular features, structures, or characteristics, but not every embodiment or example necessarily includes the particular features, structures, or characteristics. Further, it is contemplated that certain embodiments or examples may have some, all, or none of the features described for other examples. And it is to be understood that other embodiments and examples may be utilized and structural and functional modifications may be made without departing from the scope of the present disclosure.

A casino/sports-betting gaming system with methods and systems may include an odds booster game used for sports betting. The odds booster game may be a casino game that allows a bettor the chance to increase their odds for their sports bets. The odds booster game may include a random number generator operating within a machine learning algorithm and executing within a processor that generates a line adjustment graphic and/or an odds adjustment graphic and calculates and adjusts a line adjustment and an odds adjustment using the line adjustment graphic and the odds adjustment graphic. The line adjustment graphic and the odds adjustment graphic may be defined as wheels or WagerWheels, where a bettor will simply choose a desired bet, enter a bet amount, and spin the wheel(s) and depending on the outcome of the spin, the wheel results will either add or subtract to the selected line and/or odds. Other line adjustment graphics and odds adjustment graphics as defined and detailed below may be utilized with the odds booster game and the casino/sports-betting gaming system with methods and systems.

The present application is directed to a casino/sports-betting gaming system (WagerWheel) with methods and systems for a casino game/add-on used for sports betting. The casino/sports-betting gaming system may include a casino game/add-on that is used for sports betting. This game/add-on will allow the user the chance to increase the odds of sports bets. A user may pay a small fee to spin an odds booster wheel(s), that may include one or more of the following: fixed fees, fees based on a percentage of the wagers, and/or pay-per spin fee. By using positive and negative numbers, each wheel may affect the outcome of the original betting line. Odds can be increased or decreased relative to the original betting line (selected by the user) by either adding or subtracting the wheel spin results. There can be multiple wheels. One wheel will change the betting line which may include: point spread, game totals (i.e. over/unders), team totals, player props, or any other bet type that is offered. The other wheel will change the odds or moneylines. Using a wheel(s) as an odds booster will allow the guest to have the chance at boosted odds for any game, any sport and any bet type.

Other items other than a wheel may be used to “spin” or change the odds booster for the casino game/add-on for the casino/sports-betting gaming system without departing from this invention. For example, instead of a spinning wheel, a user may swipe or initiate the moving of a horizontal or vertical changing pane, such as by using a lever or button or other initiation object. In another example, instead of a spinning wheel, a user may initiate the selection of a small box within in a larger box or rectangle full of various odds boosting objects using a button or selection object. Other types of selections and changes of the odds booster may be utilized instead of the wheel without departing from this invention.

Embodiments herein may be directed to various systems, devices and methods for sports betting that use user input for sports wagers on a user terminal or mobile device, for placing a sports wager on an upcoming live or virtual sporting event. Embodiments herein may be directed to various systems, devices and methods for sports betting that use user input for sports wagers on a user terminal or mobile device, for placing an in-game live sports wager on a live or virtual sporting event during the live or virtual sporting event. Embodiments herein may be directed to various systems, devices and methods for sports betting for placing a futures sports wager on a future sporting event or outcome.

Further, events/games as disclosed herein may include live or virtual sporting events such as professional sporting events, amateur and/or collegiate sporting events among others.

Sporting events may include any team sport or contest and/or any individual sport or contest. Sports may include any sports corresponding to balls, pucks, stones, swords, cards, dice, trivia knowledge, tracks, hurdles, javelins, rackets, firearms, bows, and/or weights, among others. The virtual sporting events may include outcomes of simulated sports competitions.

Embodiments disclosed herein may be performed using a gaming device to perform sports betting. As used herein, a gaming device may include mobile devices, personal computers, kiosks and/or sports betting terminals, among others. The in-play sports bet is a real time bet in which the user predicts the actions of the team or team member or the result of the team in the near future such as the next down, next service, next possession and/or next turn. The user can wager real money, virtual money and/or points.

In a typical wager sequence in which the user begins by selecting one or more game/event outcomes first, then selects a wager type and finally enters the wager amount. The user may then select an odds booster/line adjustment that includes embodiments of a casino/sports-betting gaming system with a machine learning algorithm and/or a random number generator.

Aspects of the disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

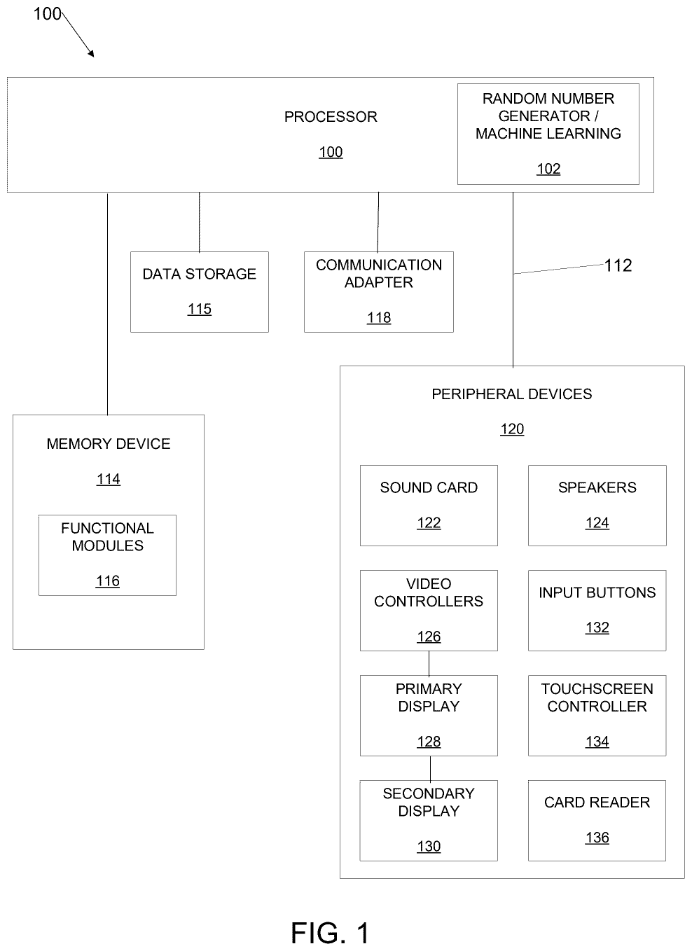

FIG. 1 depicts a schematic block diagram that illustrates various components of an exemplary computing device or casino/sports-betting gaming system, according to some embodiments. As shown in FIG. 1, the casino/sports-betting gaming system 100 may include a processor 110 that controls the operations of the casino/sports-betting gaming system 100. Although illustrated as a single processor, multiple special purpose and/or general-purpose processors and/or processor cores may be provided in the casino/sports-betting gaming system 100. For example, the casino/sports-betting gaming system 100 may include one or more of a video processor, a signal processor, a sound processor and/or a communication controller that performs one or more control functions within casino/sports-betting gaming system 100. The processor 110 may be variously referred to as a “controller,” “microcontroller,” “microprocessor” or simply a “computer.” The processor 110 may further include one or more application-specific integrated circuits (ASICs).

Various components of the casino/sports-betting gaming system 100 are illustrated in FIG. 1 as being connected to the processor 110. It will be appreciated that the components may be connected to the processor 110 and/or each other through one or more busses 112 including a system bus, a communication bus and controller, such as a USB controller and USB bus, a network interface, or any other suitable type of connection.

The casino/sports-betting gaming system 100 may further include a memory device 114 that stores one or more functional modules 116 for performing the operations described above. Alternatively, or in addition, the casino/sports-betting gaming system 100 may further include a data storage device 115 that stores other data and information pertinent to the casino/sports-betting gaming system 100. For example, the data storage device 115 may include wager data corresponding to a plurality of live or virtual sporting events and/or events and betting lines and/or wagers on those sporting events and events. Alternatively, or in addition, some of the operations of the casino/sports-betting gaming system 100 above may be performed by other devices connected to the network, such as a network of a system of a plurality of casino/sports-betting gaming devices, for example. The casino/sports-betting gaming system 100 may communicate with other devices connected to the network to facilitate performance of some of these operations. For example, the casino/sports-betting gaming system 100 may communicate and coordinate with certain displays to identify elements being displayed by a particular display.

The memory device 114 may store program code and instructions, executable by the processor 110, to control the casino/sports-betting gaming system 100. The memory device 114 may include random access memory (RAM), which can include non-volatile RAM (NVRAM), magnetic RAM (ARAM), ferroelectric RAM (FeRAM) and other forms as commonly understood in the gaming industry. In some embodiments, the memory device 114 may include read only memory (ROM). In some embodiments, the memory device 114 may include flash memory and/or EEPROM (electrically erasable programmable read only memory). Any other suitable magnetic, optical and/or semiconductor memory may operate in conjunction with the gaming device disclosed herein.

The casino/sports-betting gaming system 100 may include a communication adapter 118, which may also be referred to as a communication interface and that enables the casino/sports-betting gaming system 100 to communicate with remote devices, such as the wireless network, another casino/sports-betting gaming system 100, and/or a wireless access point, over a wired and/or wireless communication network, such as a local area network (LAN), wide area network (WAN), cellular communication network, or other data communication network.

The casino/sports-betting gaming system 100 may include one or more internal or external communication ports that enable the processor 110 to communicate with and to operate with internal or external peripheral devices 120, such as one or more of: a sound card 122 and speakers 124, video controllers 126, a primary display 128, a secondary display 130, input buttons 132, or other devices such as switches, keyboards, pointer devices, and/or keypads, a touch screen controller 134, a card reader 136, currency acceptors and/or dispensers, cameras, sensors such as motion sensors, mass storage devices, microphones, haptic feedback devices, and/or wireless communication devices. In some embodiments, internal or external peripheral devices may communicate with the processor 110 through a universal serial bus (USB) hub (not shown) connected to the processor 110. Although illustrated as being integrated with the casino/sports-betting gaming system 100, any of the components therein may be external to the casino/sports-betting gaming system 100 and may be communicatively coupled thereto. Although not illustrated, the casino/sports-betting gaming system 100 may further include a rechargeable and/or replaceable power device and/or power connection to a main power supply, such as a building power supply.

Additionally, the casino/sports-betting gaming system 100 used for sports betting may include a machine learning algorithm and/or a random number generator 102 that may execute or operate on the casino/sports-betting gaming system 100. Upon user selection of the casino/sports-betting gaming system 100, a machine learning algorithm and/or a random number generator 102 may calculate and adjust the new odds.

The casino/sports-betting gaming system 100 may utilize a machine learning algorithm and/or random number generator 102 for learning trends and improving analyzing, calculating, identifying, weighting betting and odds booster information and values from historical determinations. Unlike traditional fixed odds, the machine learning algorithm and/or random number generator 102 may recalculate the odds in real-time, based on the machine learning algorithm and/or random number generator 102. The flexibility of the machine learning algorithm and/or random number generator 102 allows for customization of odds and math which allows the sportsbook operator to tailor the game to their liking. Allowing the sportsbook operator to tailor the odds to their liking may help the sportsbook operator to align with their promotional goals and/or helps them cater to the preferences of their unique bettor/user base. The machine learning algorithm and/or random number generator 102 may provide a variety of outcomes. For example, the machine learning algorithm and/or random number generator 102 may allow a wide range of possible outcomes which may include favorable odds that increase a user's potential winnings, or challenging odds that add an element of risk and unpredictability. The variety of the machine learning algorithm and/or random number generator 102 may keep users intrigued and engaged.

The machine learning algorithm and/or random number generator 102 may utilize one or more of a variety of machine learning architectures known and used in the art. These architectures can include, but are not limited to, random number generators (RNG), neural networks (NN), recurrent neural networks (RNN), convolutional neural networks (CNN), transformers, and/or probabilistic neural networks (PNN), linear regression, random forest, decision trees, k-nearest neighbors, support vector machines (SVM), logistical regression, k-means clustering, association rules. RNNs can further include (but are not limited to) fully recurrent networks, Hopfield networks, Boltzmann machines, self-organizing maps, learning vector quantization, simple recurrent networks, echo state networks, long short-term memory networks, bi-directional RNNs, hierarchical RNNs, stochastic neural networks, and/or genetic scale RNNs. In a number of embodiments, a combination of machine learning architectures can be utilized, more specific machine learning architectures when available, and general machine learning architectures at other times can be used. Additionally, the machine learning algorithm may use semi-supervised learning and/or reinforcement learning.

First, a user will go through the traditional process of placing a bet on a sportsbook. The user will: 1) Navigate to desired game and bet type; 2) Click on the desired bet; 3) Selected bet will pop up into bet slip; 4) Enter bet $ amount. Instead of placing that bet like the user traditionally would, the casino/sports-betting gaming system 100 will provide a game where users may pay a fee to spin one or more wheel(s) to try and increase their odds. The user may pay a fee to participate in the odds booster game that may include, but not be limited to, one or more of the following: fixed fees, fees based on a percentage of the wagers, and/or pay-per spin fee.

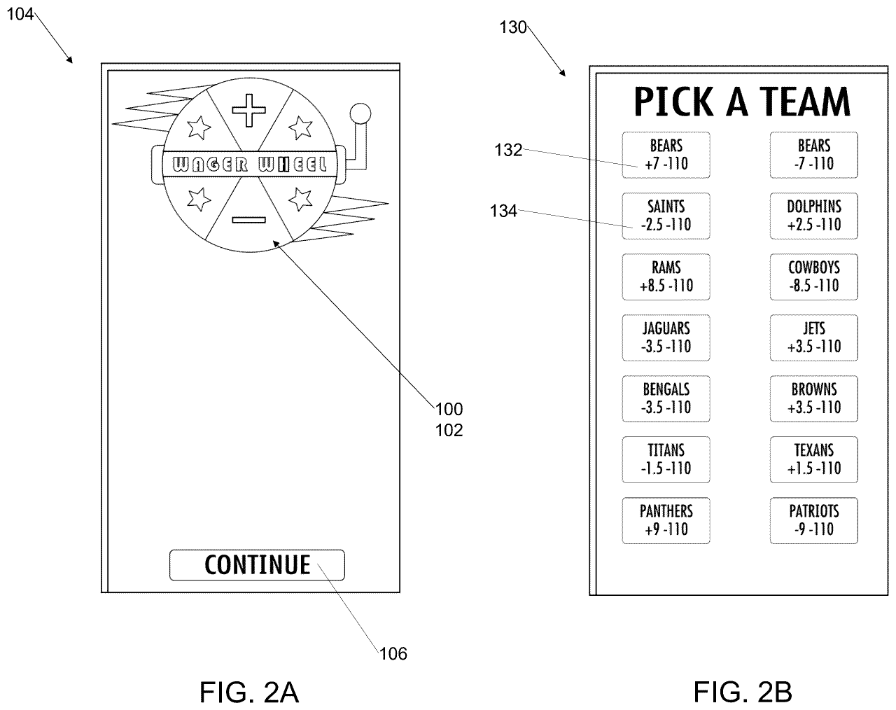

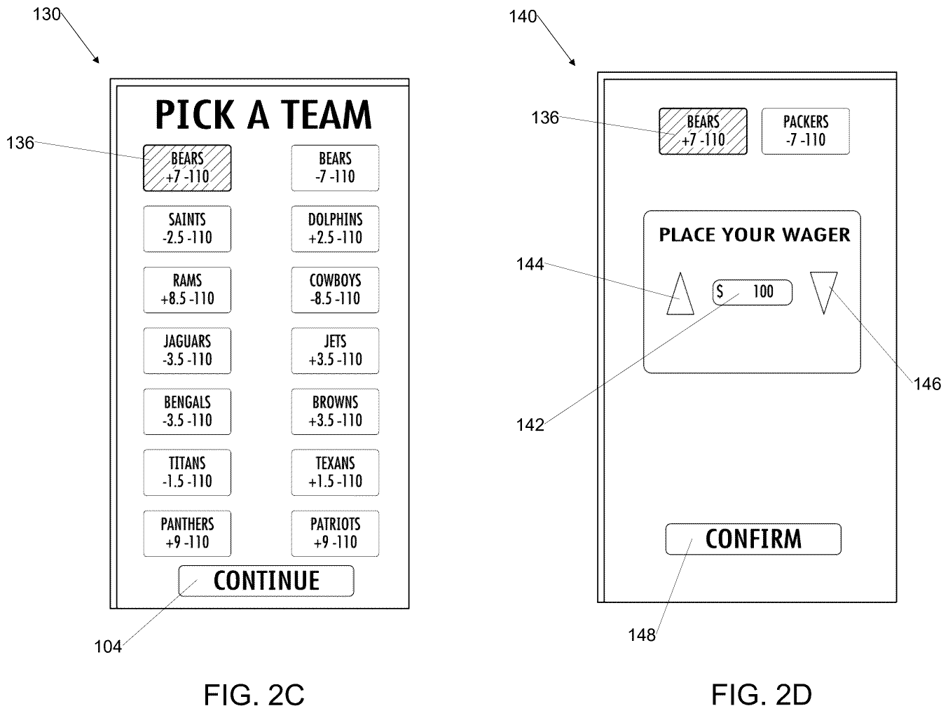

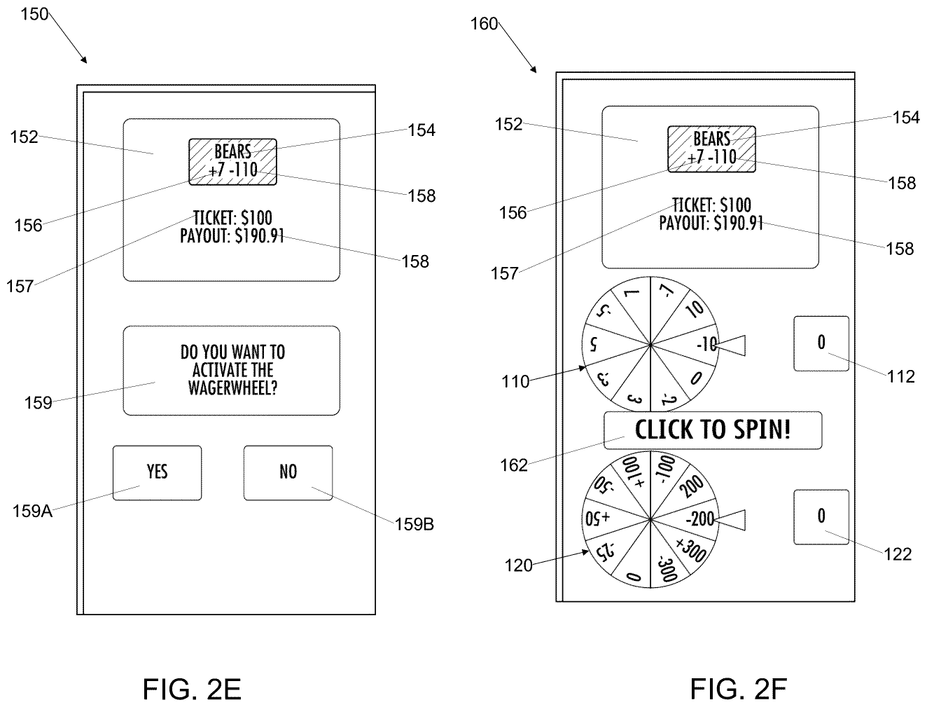

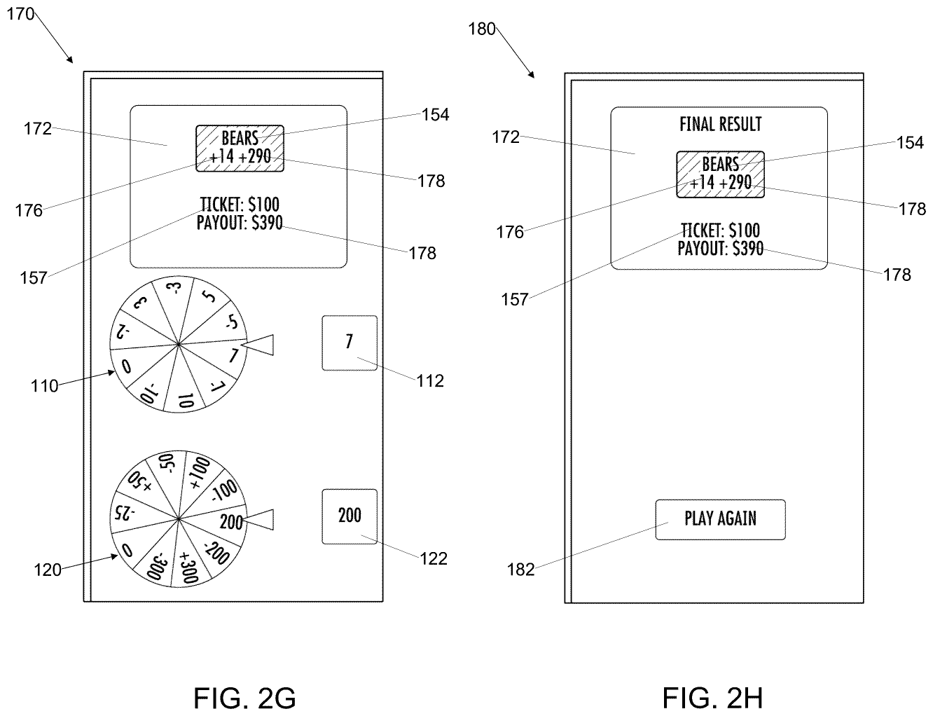

FIGS. 2A-2H depict a schematic exemplary view of a mobile device displaying a screenshot of a graphical user interface with the casino/sports-betting gaming system 100, according to some embodiments.

FIG. 2A illustrates an exemplary welcome screen 104 for the casino/sports-betting gaming system 100. Any welcome screen 104 may be used with the casino/sports-betting gaming system 100. In some embodiments, the casino/sports-betting gaming system 100 may not include a welcome screen. The welcome screen 104 may also include a “CONTINUE” button 106 that takes the user to the next screen.

FIG. 2B illustrates an exemplary game screen 130 for the casino/sports-betting gaming system 100. The game screen 130 may include a list of one or more of the games available to the user. Each of the games may be listed with both teams. For example, the first game 132 lists the Bears at +7 points and −110 odds playing the Packers at −7 points and −110 odds. The second game 134 lists the Saints at −2.5 points at −110 odds playing the Dolphins at +2.5 points at −110. Etc. The game screen 130 may include various and different ways to list these games to the user, without departing from the embodiments, that are known and used in the art.

FIG. 2C illustrates the game screen 130 with the user's game selection highlighted 136. As shown in FIG. 2C, the user has selected the Bears at +7 points and −110 odds. The “CONTINUE” button 106 may appear on the game screen 130 after the user selects a game.

FIG. 2D illustrates an exemplary wager screen 140 for the casino/sports-betting gaming system 100. The wager screen 140 may include the user's game selection 136. The wager screen 140 may also include a wager entry box 142 to enter a wager amount. The wager screen 140 may also include an up arrow 144 and a down arrow 146 to increase or decrease the wager amount from the wager entry box 142. The up arrow 144 may be other symbols that represent increasing the wager amount, such as a plus sign, without departing from the embodiments. The down arrow 146 may be other symbols that represent decreasing the wager amount, such as a minus sign, without departing from the embodiments. A “CONFIRM” button 148 may also be provided on the wager screen 140 for the user to select and confirm the wager after the user has entered the wager amount.

FIG. 2E illustrates an exemplary wager summary screen 150 for the casino/sports-betting gaming system 100. The wager summary screen 150 may include a wager summary 152. The wager summary 152 may include a listing of a team 154, a line 155, and odds 156 for the user's wager. The wager summary 152 may also include a wager amount 157 and a wager payout 158 for that wager summary 152. As depicted in FIG. 2E, the wager summary 152 shows the Bears as the team 154, +7 as the line 155, −110 as the odds 156, $100 as the wager amount 157, and $190.91 as the wager payout 158.

The wager summary screen 150 may also include a selection for an odds booster game/add-on 159 (for example, WagerWheel), that may include a “YES” 159A selection button and a “NO” 159B selection button. The odds booster game/add-on 159 may allow the user the chance to increase the odds of sports bets. In some embodiments, the user may pay a small fee to select and play the odds booster game and/or spin an odds booster wheel(s). The user may pay a fee to play the odds booster game and/or spin an odds booster wheel(s) that may include, but not be limited to, one or more of the following: fixed fees, fees based on a percentage of the wagers, and/or pay-per spin fee. In other embodiments, the user may not pay a small fee to select and play the odds booster game and/or spin an odds booster wheel(s).

FIG. 2F illustrates an odds booster game/add-on screen 160 from the casino/sports-betting gaming system 100 after the user selects the “YES” 159A selection button. The odds booster game/add-on screen 160 may include the wager summary 152 as provided on the wager summary screen 150. Upon selection of the odds/booster game/add-on by the user, the casino/sports-betting gaming system 100 may include a machine learning algorithm and/or random number generator 102. The casino/sports-betting gaming system 100 and the machine learning algorithm and/or random number generator 102 may calculate and adjust the new odds through a visual graphics as shown in one or more wheels 110, 120.

The odds booster game/add-on screen 160 may include the one or more wheels 110, 120 to allow the user the chance to increase the odds and/or change the line of the wager. Odds can be increased or decreased relative to the original betting line (selected by the user) by either adding or subtracting the wheel spin results. The odds booster game/add-on screen 160 may include multiple wheels. For example, a first wheel or line differential wheel 110 may change the betting line which may include: point spread, game totals (i.e. over/unders), team totals, player props, or any other bet type that is offered. A second wheel or odds wheel 120 may change the odds or moneylines. Using the wheel(s) 110, 120 as an odds booster will allow the guest to have the chance at boosted odds for any game, any sport and any bet type. The odds booster game/add-on screen 160 may also include one or more output boxes 112, 122. The line differential wheel 110 may be adjacent to or near a line differential output box 112. The odds wheel 120 may be adjacent to or near an odds output box 122. Prior to spinning the wheels 110, 120, the output boxes 112, 122 both may read “0”.

Other items different than a wheel 110, 120 may be used to “spin” or change the odds booster for the casino game/add-on for the casino/sports-betting gaming system 100 without departing from this invention. For example, instead of a spinning wheel, a user may swipe or initiate the moving of a horizontal or vertical changing pane, such as by using a lever or button or other initiation object. In another example, instead of a spinning wheel, a user may initiate the selection of a small box within in a larger box or rectangle full of various odds boosting objects using a button or selection object. Other types of selections and changes of the odds booster may be utilized instead of the wheel without departing from this invention. In other examples, for example, instead of spinning a wheel, the odds booster game may also include a rotating sphere or shape that matches or is relevant to a sports-related shape, i.e. a sports related ball (football, basketball, baseball, soccer ball, etc), sports equipment (baseball bat, hockey stick, football helmet), etc. In yet other examples, for example, instead of spinning a wheel the odds booster game may also include a spinning disk that includes relevant sports imagery or other forms of symbols, such as logos, teams, leagues, etc. In yet other examples, for example, instead of spinning a wheel the odds booster game may also include other items, such as a card display, digital dice, and/or slot machine reels. All of these above options may be used with each other or in combination with one or more of the above different options for the wheels 110, 120 as depicted in these FIGS. 2F and 2G.

The odds booster game/add-on screen 160 may also include a “Click to Spin!” button 162. The “Click to Spin!” button 162, or similar button or input, initiates the one or more boosting objects/items, such as starts spinning the wheels 110, 120.

FIG. 2G depicts an odds booster result screen 170. The odds booster result screen 170 shows an exemplary result after the user presses the “Click to Spin!” button 162 and initiates the spinning of the wheels 110, 120.

As illustrated in FIG. 2G, the casino/sports-betting gaming system 100 includes the first wheel or line differential wheel 110 which may add/subtract to the original line that the user selected and the second wheel or the odds wheel 120 which may increase or decrease the original odds that the user selected. In the example depicted in FIG. 2G, the user got +7 (plus 7) on the line differential wheel 110. This spin on the line differential wheel 110 would add 7 points to the original line selected. The original line now moves 7 points in the favor of the user from the original line, taking the original line of +7 to +14. Additionally, the odds may change for the user during the spin and the odds may be boosted relative to the original line. As illustrated in FIG. 2G, the odds wheel 120 would affect and/or change the odds of the bet that the user selected. For example, whatever the spin lands on with the odds wheel 120, will be user's new odds for their original bet. In the example depicted in FIG. 2G, the user got “200” on the odds wheel 120. These new odds are boosted odds which may be relative to the original odds. The user will now get paid out +200 or 2-1 if the bet wins, instead of getting paid the original odds of −110. FIG. 2G illustrates a spin of the wheel(s) 110, 120 that result in both a line change differential and boosted odds which are favorable for the user.

The odds booster result screen 170 may also include the adjusted wager summary 172 as adjusted with the line differential and the odds adjustment from the original wager summary 152 as provided on the wager summary screen 150. In this example, the adjusted wager summary 172 may include a listing of the team 154, the adjusted line 175, and adjusted odds 176 for the user's wager. The adjusted wager summary 172 may also include the wager amount 157 and an updated wager payout 178 for that adjusted wager summary 172. As depicted in FIG. 2G, the adjusted wager summary 172 shows the Bears as the team 154, +14 as the adjusted line 175 (moving from +7 to +14), +200 as the adjusted odds 176 (moving from −110 to +200), $100 as the wager amount 157, and $390 as the adjusted wager payout 178 (adjusted from $190.91 to $390). The adjusted odds 176 may be provided by the sportsbook/casino operator and the casino/sports-betting gaming system 100 to have flexibility in how the winnings are awarded to the users. For example, the adjusted odds 176 may be provided as fixed odds or as variable odds based on the user's selections. Additionally, in another embodiment, the adjusted odds 176 may be provided by the sportsbook/casino operator and the casino/sports-betting gaming system 100 to adapt the odds booster game towards the goals of the sportsbook/casino operator. The adjusted odds 176 may include odds that are tailored towards the promotional strategies of the sportsbook/casino operator, for example, the adjusted odds 176 may be only positive or the adjusted odds 176 may be both positive and negative.

FIG. 2H depicts a final result screen 180. The final result screen 180 includes the adjusted wager summary 172, showing the listing of the team 154, the adjusted line 175, adjusted odds 176 for the user's wager, the wager amount 157, and the updated wager payout 178. The final result screen 180 may also include a “PLAY AGAIN” button 182. The final result screen 180 may also include inputs to finalize the bet or selecting another bet, etc.

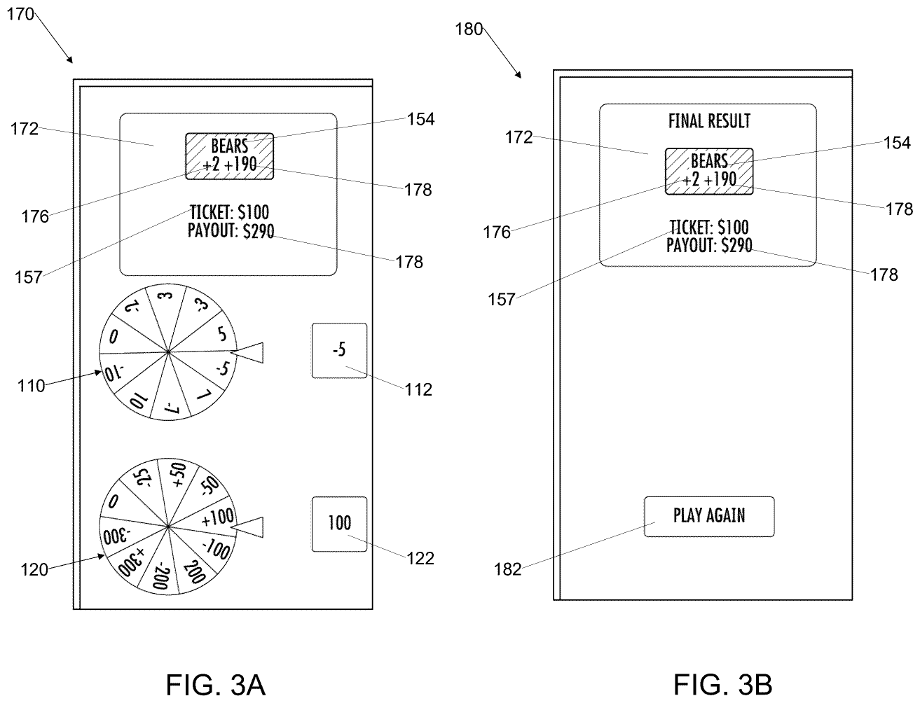

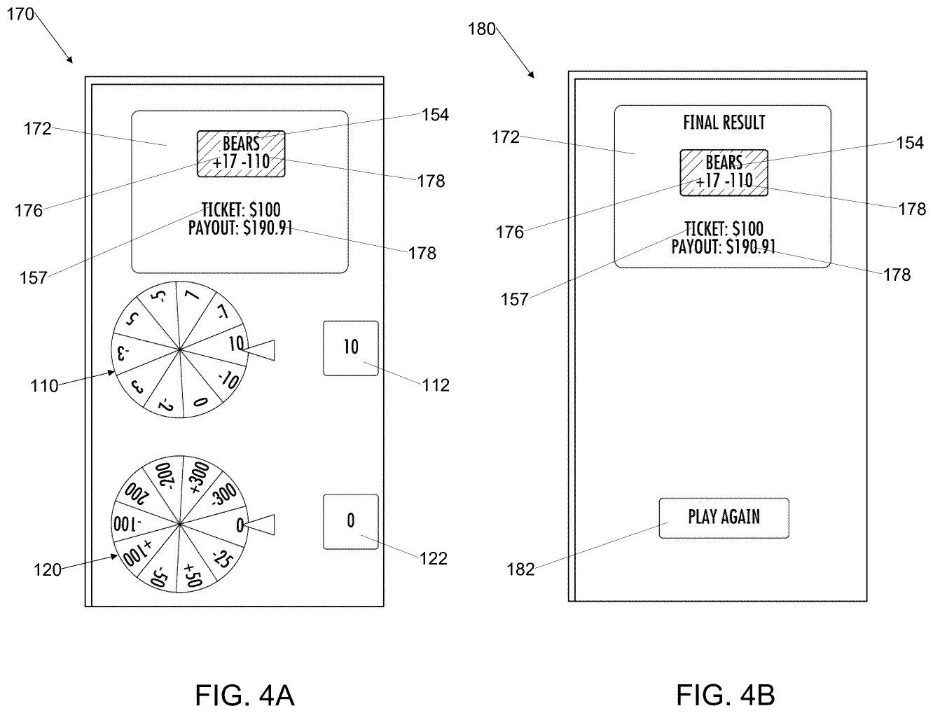

FIGS. 3A-3B and 4A-4B depict exemplary screenshots for other outcomes similar to the outcome depicted in FIGS. 2G and 2H, but with differences in both the line differential wheel 110 and the odds wheel 120. FIGS. 3A-4B depict another exemplary results for a spin of the wheels 110, 120 with the odds booster result screen 170 and the final result screen 180. FIGS. 2A-2H illustrates a spin of the wheels 110, 120 that can result in a line differential change and boosted odds which are favorable for the user. FIGS. 3A and 3B illustrates a spin of the wheels 110, 120 that can result in a line differential change that is favorable for the sportsbook operated and a boosted odds which are favorable for the user. FIGS. 4A and 4B illustrates a spin of the wheels 110, 120 that can result in a line differential change that is neutral for both the user and the sportsbook operated and a boosted odds which are favorable for the user.

In the example depicted in FIG. 3A, the user got −5 (minus 5) on the line differential wheel 110. This spin on the line differential wheel 110 would subtract 5 points from the original line selected. The original line now moves 5 points in the favor of the sportsbook operator from the original line, taking the original line of +7 to +2. Additionally, the odds may change for the user during the spin and the odds may be boosted relative to the original line. In the example depicted in FIG. 3A, the user got “100” on the odds wheel 120. These new odds are boosted odds which may be relative to the original odds. The user will now get paid out +100 or 1-1 if the bet wins, instead of getting paid the original odds of −110. FIG. 3A illustrates a spin of the wheel(s) 110, 120 that result in a line change differential which is favorable to the sportsbook operator and boosted odds which are favorable for the user.

In the example depicted in FIG. 4A, the user got “0” (zero) on the line differential wheel 110. This spin on the line differential wheel 110 would keep the original line the same as was selected, keeping the original line at +7. Additionally, the odds may change for the user during the spin and the odds may be boosted relative to the original line. In the example depicted in FIG. 4A, the user got “200” on the odds wheel 120. These new odds are boosted odds which may be relative to the original odds. The user will now get paid out +200 or 1-1 if the bet wins, instead of getting paid the original odds of −110. FIG. 4A illustrates a spin of the wheel(s) 110, 120 that result in a line differential change that is neutral for both the user and the sportsbook operated and a boosted odds which are favorable for the user.

There are any number of combinations which can occur using the casino/sports-betting gaming system 100 with the line differential wheel 110 and the odds wheel 120. For example, in a first example, the line differential wheel 110 may be favorable to the user and the odds wheel 120 may be favorable to the user (as depicted in FIG. 2G). In another example, the line differential wheel 110 may be favorable to the sportsbook operator (and unfavorable to the user) and the odds wheel 120 may be favorable to the sportsbook operator (and unfavorable to the user). In another example, the line differential wheel 110 may be favorable to the user and the odds wheel 120 may be favorable to the sportsbook operator (and unfavorable to the user) (as depicted in FIG. 3A). In yet another example, the line differential wheel 110 may be favorable to the sportsbook operator (and unfavorable to the user) and the odds wheel 120 may be favorable to the user. Additionally, the line differential wheel 110 and/or the odds wheel 120 may be neutral or no change with regards to the user and the sportsbook operator (as depicted in FIG. 4A for the line differential wheel 110).

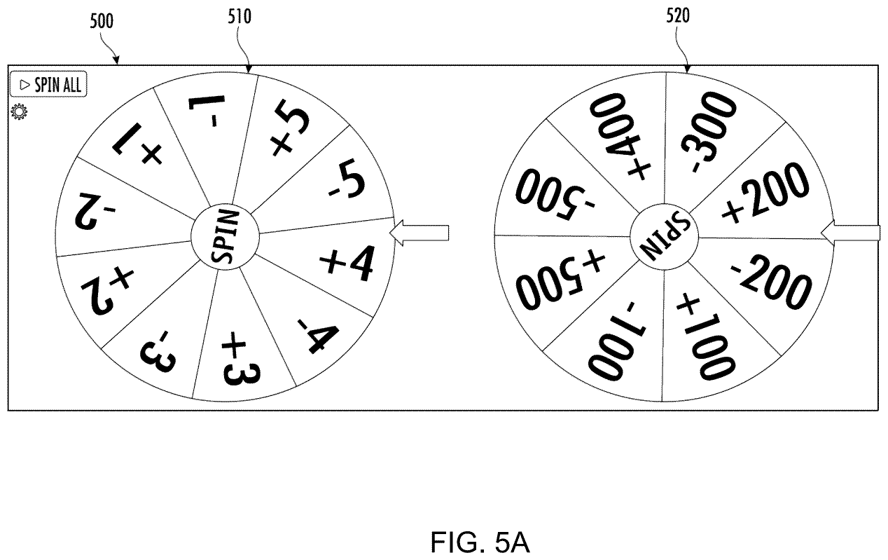

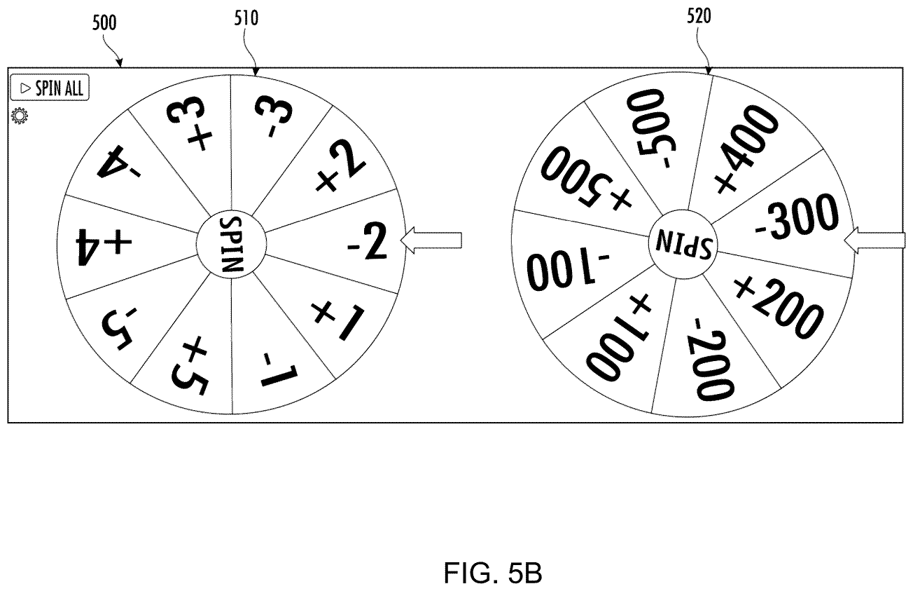

FIGS. 5A and 5B depict an exemplary line differential wheel 510 and odds wheel 520 for another casino/sports-betting gaming system 500. FIG. 5A illustrates a spin of the wheel(s) 510, 520 that can result in boosted odds which can be favorable for the user. FIG. 5B illustrates a spin of the wheel(s) 510, 520 that can result in boosted odds which can be favorable for the sportsbook operator.

As illustrated in FIG. 5A, the casino/sports-betting gaming system 500 may include two wheels 510, 520. The first wheel or line differential wheel 510 may add/subtract to the original line that the user selected. The second wheel or the odds wheel 520 may increase or decrease the original odds that the user selected. First, the user may spin the line differential wheel 510 and, in the example depicted in FIG. 5A, the user got +4 (plus 4) on the line differential wheel 510. This spin on the line differential wheel 510 would add 4 points to the original line selected. The original line now moves 4 points in the favor of the user from the original line. Additionally, the odds may change for the user during the spin and the odds may be boosted relative to the original line. As illustrated in FIG. 5A, the odds wheel 520 would affect and/or change the odds of the bet that the user selected. For example, whatever the spin lands on with the odds wheel 520, will be user's new odds for their original bet. Next, the user may spin the odds wheel 520 and, in the example depicted in FIG. 5A, the user got +200 on the odds wheel 520. These new odds are boosted odds which may be relative to the original odds. The user will now get paid out 2-1 if the bet wins, instead of getting paid the original odds. FIG. 5A illustrates a spin of the wheel(s) 510, 520 that can result in boosted odds which can be favorable for the user.

FIGS. 5A and 5B depict an exemplary line differential wheel 510 and odds wheel 520 for another casino/sports-betting gaming system 500. FIG. 5A illustrates a spin of the wheel(s) 510, 520 that can result in boosted odds which can be favorable for the user. FIG. 5B illustrates a spin of the wheel(s) 510, 520 that can result in boosted odds which can be favorable for the sportsbook operator.

As illustrated in FIG. 5A, the casino/sports-betting gaming system 500 may include two wheels 510, 520. The first wheel or line differential wheel 510 may add/subtract to the original line that the user selected. The second wheel or the odds wheel 520 may increase or decrease the original odds that the user selected. First, the user may spin the line differential wheel 510 and, in the example depicted in FIG. 5A, the user got +4 (plus 4) on the line differential wheel 510. This spin on the line differential wheel 510 would add 4 points to the original line selected. The original line now moves 4 points in the favor of the user from the original line. Additionally, the odds may change for the user during the spin and the odds may be boosted relative to the original line. As illustrated in FIG. 5A, the odds wheel 520 would affect and/or change the odds of the bet that the user selected. For example, whatever the spin lands on with the odds wheel 520, will be user's new odds for their original bet. Next, the user may spin the odds wheel 520 and, in the example depicted in FIG. 5A, the user got +200 on the odds wheel 520. These new odds are boosted odds which may be relative to the original odds. The user will now get paid out 2-1 if the bet wins, instead of getting paid the original odds. FIG. 5A illustrates a spin of the wheel(s) 510, 520 that can result in boosted odds which can be favorable for the user.

In contrast, FIG. 5B illustrates a spin of the wheel(s) 510, 520 that can result in boosted odds which can be favorable for the sportsbook operator. First, the user may spin the line differential wheel 510 and, in the example depicted in FIG. 5B, the user got −2 (minus 2) on the line differential wheel 510. This spin on the line differential wheel 510 would subtract 2 points to the original line selected. The original line now moves 2 points in the favor of the sportsbook operator (and unfavorable to the user) from the original line. Additionally, the odds may change for the user during the spin and the odds may be boosted relative to the original line. As illustrated in FIG. 5B, the odds wheel 520 would affect and/or change the odds of the bet that the user selected. For example, whatever the spin lands on with the odds wheel 520, will be user's new odds for their original bet. Next, the user may spin the odds wheel 520 and, in the example depicted in FIG. 5B, the user got −300 (minus 300) on the odds wheel 520. These new odds are boosted odds which may be relative to the original odds. The user will now get paid out ⅓ (−300) if the bet hits instead of getting paid the original odds, which is again favorable for the sportsbook operator and unfavorable to the user.

As was described above with regards to FIGS. 2A-2H, 3A, 3B, 4A, and 4B, there are any number of combinations which can occur using the casino/sports-betting gaming system 500 with the line differential wheel 510 and the odds wheel 520. For example, in a first example, the line differential wheel 510 may be favorable to the user and the odds wheel 520 may be favorable to the user (as depicted in FIG. 5A). In another example, the line differential wheel 510 may be favorable to the sportsbook operator (and unfavorable to the user) and the odds wheel 520 may be favorable to the sportsbook operator (and unfavorable to the user) (as depicted in FIG. 5B). In another example, the line differential wheel 510 may be favorable to the user and the odds wheel 520 may be favorable to the sportsbook operator (and unfavorable to the user). In yet another example, the line differential wheel 510 may be favorable to the sportsbook operator (and unfavorable to the user) and the odds wheel 520 may be favorable to the user.

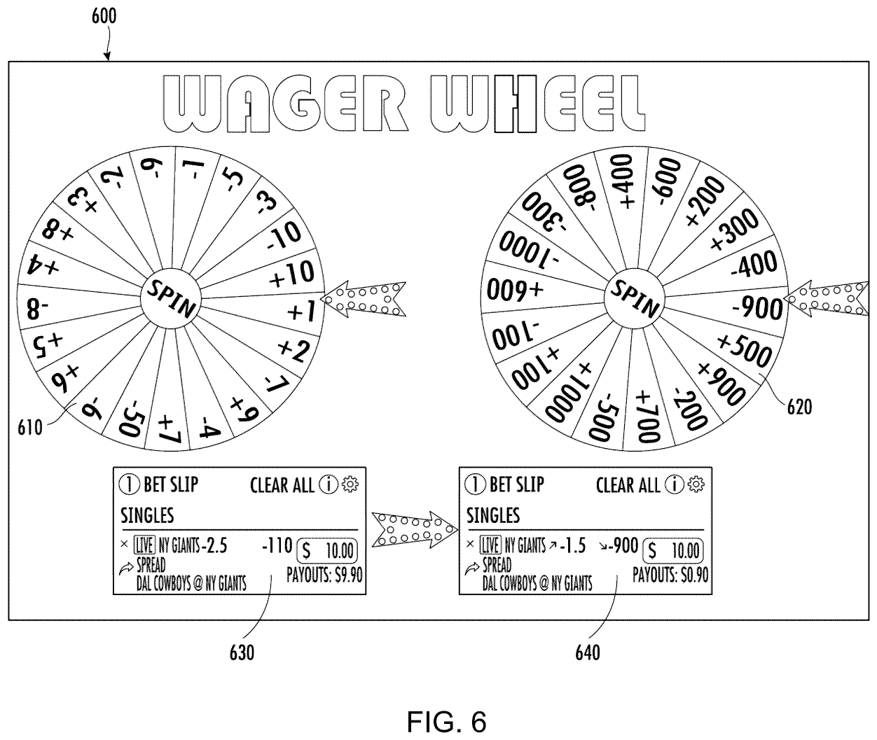

FIG. 6 illustrates another exemplary embodiment of the casino/sports-betting gaming system 600, which represents an illustration of what the game may look like, two wager wheels 610, 620, the wheel spin results 630, payout adjustments and betting line adjustments 640 (relative to the original selected bet type and listed odds).

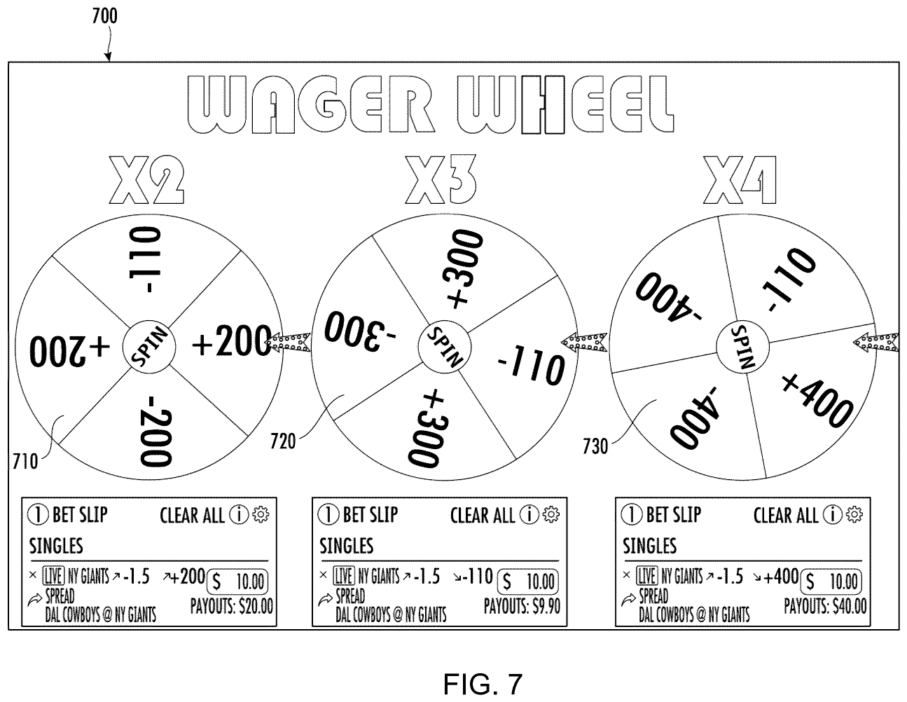

FIG. 7 illustrates another exemplary embodiment of the casino/sports-betting gaming system 700, which represents how an odds booster can be used without forgoing the house edge, being taken advantage of, and still offer users a chance at boosted odds.

With the casino/sports-betting gaming system 700 shown in FIG. 7, the user may pay a small fee to spin an odds booster wheel(s) 710, 720, 730. For example, the fee may vary depending on the potential payout and the wheel that the user selects to spin. The higher the potential payout, the higher the fee. For example, if the user wants to spin the first wheel 710, the X2 Wheel (2 times multiple), the fee may be 20% of amount wagered. If the user wants to spin the second wheel 720, the X3 Wheel (3 times multiple), the fee may be 30% of amount wagered. If the user wants to spin the third wheel 730, the X4 Wheel (4 times multiple), the fee may be 40% of amount wagered. In other examples, the fee may include, but not be limited to, one or more of the following: fixed fees, fees based on a percentage of the wagers, and/or pay-per spin fee.

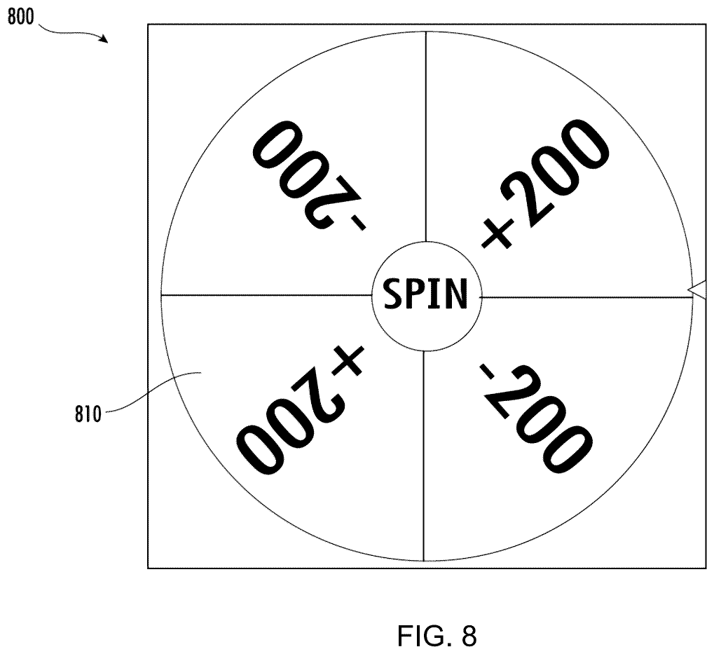

FIG. 8 illustrates yet another exemplary embodiment of the casino/sports-betting gaming system 800. The casino/sports-betting gaming system 800 may include a single wheel 810 that includes an odds wheel 810 that has one or more positive outcomes/odds for the user and an equal amount of one or more negative outcomes/odds for the user. In the example depicted in FIG. 8, the odds wheel 810 includes two +200 odds boosters for the user and two −200 odds boosters for the user. In other embodiments, the casino/sports-betting gaming system 800 may include a single wheel 810 that is a line differential wheel that has one or more positive outcomes/point differentials for the user and an equal amount of one or more negative outcomes/point differentials for the user. For example, a single line differential wheel may include two +7 point differentials for the user and two −7 point differentials for the user.

For example, with traditional odds, if the Bears are playing the Packers and the money line is −110 for both teams, the odds/edge for the sportsbook operator would be 4.55%. When using the casino/sports-betting gaming system 800 and the wager wheel 810 shown in FIG. 8, there is a 50% chance the wager wheel 810 lands on −200 and a 50% chance the wager wheel 810 lands on +200. If the wager wheel 810 lands on −200, the odds/edge for the sportsbook operator would be 16%. If the wager wheel 810 lands on +200, the odds/edge for the sportsbook operator would be −16.67%. By charging the user, for example, a 20% fee to spin the wager wheel 810 (20% of the bet amount), this 20% fee would offset the potential loss of a +200 spin, while still increasing the overall odds/edge for the sportsbook operator.

By using this casino/sports-betting gaming system 100, 500, 600, 700, 800 in the figures or other exemplary embodiments, the wheel setup may allow users to increase potential payouts, which increases the odds/edge for the sportsbook operator.

The casino/sports-betting gaming system 100, 500, 600, 700, 800 may include a random number generator (RNG) system, which features the various wheels as a dynamic wheel. The casino/sports-betting gaming system 100, 500, 600, 700, 800 may add more excitement, volatility, and unpredictability to the sports betting industry.

As stated earlier, volatility in sports betting relies on two variables: stake and odds. For the bettor to win a good amount of money on a straight bet, the user can either bet a large amount on a favorite (higher stake), bet a smaller amount on an underdog (higher odds), or sometimes attempt to find an odds booster promotion. Also stated earlier, there are many problems with traditional odds booster promotions, including limited offerings for the bettor and taking away some of the vig (house edge) for the sportsbook operator.

It should be understood, that any of the listed odds booster values and numbers as cited in examples for the various WagerWheel embodiments may be changed and varied without departing from this invention.

The casino/sports-betting gaming system used for sports betting game and executing on a casino/sports-betting gaming system can be used in mobile or web-based platforms, and potentially built into physical machines, terminals, or kiosks. The physical machines, terminals, or kiosks would work the same, giving land-based sportsbook operators the same benefits that the casino/sports-betting gaming system would provide to online sportsbook operators.

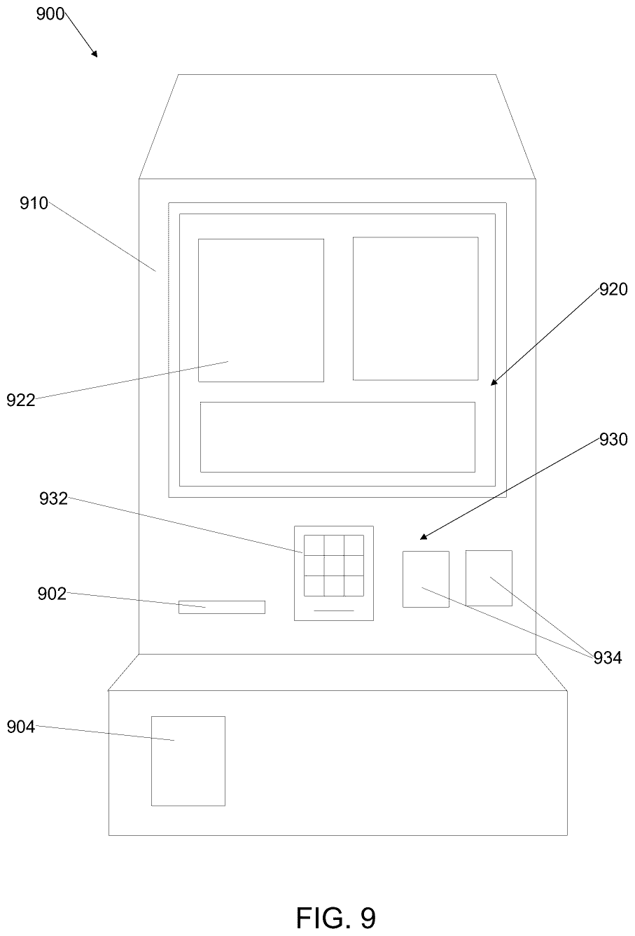

As used herein, the casino/sports-betting gaming system 100, 500, 600, 700, 800 may include a gaming device that may include, for example, an electronic gaming device such as an electronic gaming machine (EGM), gaming terminal, etc., an electromechanical gaming device, a computing device such as a personal computer, a mobile computing device such as a tablet, smartphone, etc., or another device or devices. In this regard, FIG. 9 is a schematic block diagram that illustrates a dedicated gaming terminal using a casino/sports-betting gaming system corresponding to live sporting event according to some embodiments. In some embodiments, the gaming terminal 900 includes a housing 910 having a display device 920, and a plurality of input devices 930, such as a keypad 932, buttons 934, etc., for receiving user input for playing the wagering game and otherwise interacting with the gaming terminal 900. The gaming terminal 900 may be a gaming kiosk or casino kiosk as known and used in the art. In some embodiments, the display device 920 may include a touchscreen interface for receiving user input as well. The display device 920 may also be a single display device or may include multiple display devices, such as a first display device for displaying video of the live sporting event and a second display device for displaying gaming and wagering information for example. The gaming terminal 900 may include additional specialized hardware as well, such as an acceptor 902, for receiving currency (i.e., bills and/or coins), tokens, credit or debit cards, or other physical items associated with monetary or other value. The gaming terminal 900 may also include a dispenser 904, for dispensing items, such as physical items having monetary or other value (e.g., awards or prizes) or other items.

The gaming terminal 900 may include a processor and a memory coupled to the processor. The memory may include machine-readable instructions that, when executed by the processor, cause the processor to perform operations for operating the gaming terminal 900 and/or other features described herein. In this example, the gaming terminal 900 may include a graphical user interface (GUI) 922 displayed by the display device 920 for providing the video and gaming information to the user.

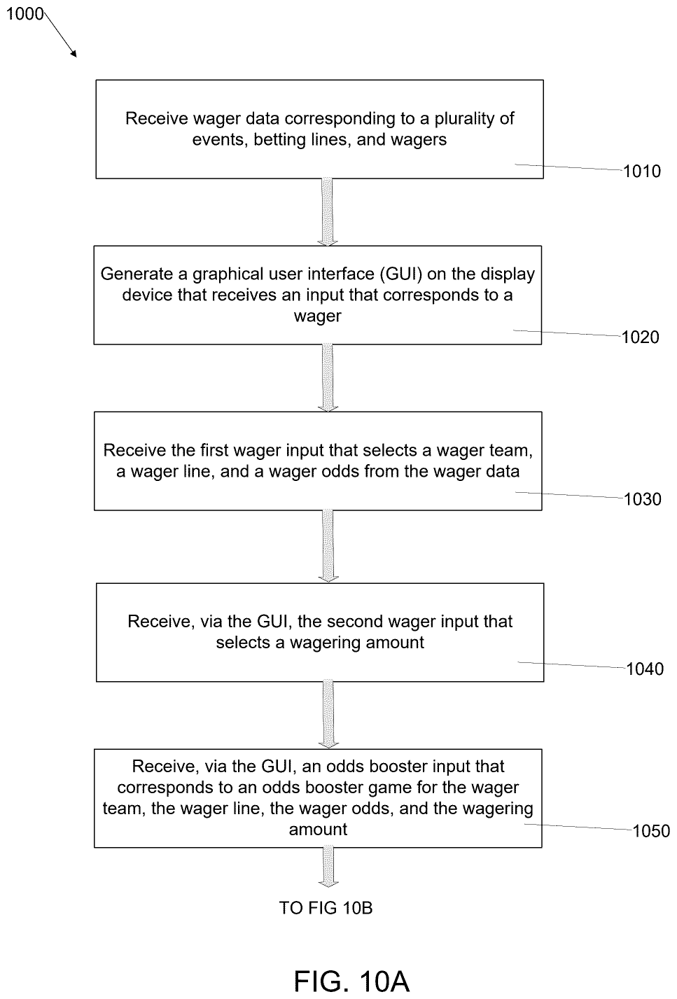

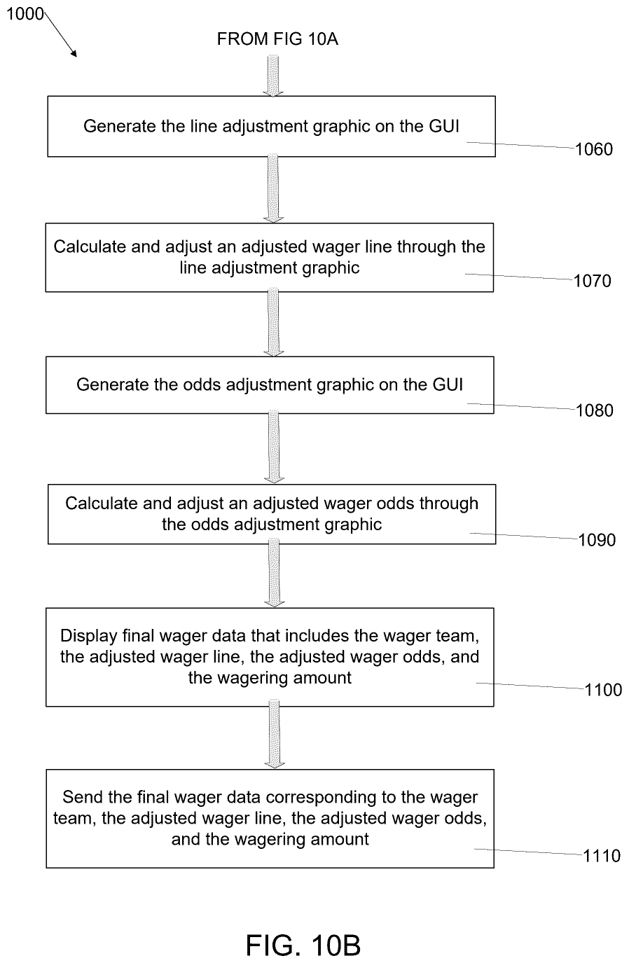

These and other features may be implemented as operations that may be executed by a processor of a computing device. Reference is now made to FIGS. 10A and 10B, which is a flowchart illustrating operations of systems/methods 1000 according to some embodiments of a casino/sports-betting gaming system.

Operations of a casino/sports-betting gaming system may include receiving 1010 wager data corresponding to a plurality of events, betting lines, and wagers. The plurality of events may include live or virtual sporting events such as professional sporting events, amateur and/or collegiate sporting events among others. Sporting events may include any team sport or contest and/or any individual sport or contest. Sports may include any sports corresponding to balls, pucks, stones, swords, cards, dice, trivia knowledge, tracks, hurdles, javelins, rackets, firearms, bows, and/or weights, among others. The virtual sporting events may include outcomes of simulated sports competitions. The wager data may include home/away indication for the plurality of events. Additionally, the wager data may include event time/date information for the plurality of events. The wager data may be received by a data storage device 115 that stores other data and information pertinent to the casino/sports-betting gaming system 100. For example, the data storage device 115 may include wager data corresponding to a plurality of sporting events and/or events and betting lines and/or wagers on those sporting events and events.

Operations of a casino/sports-betting gaming system may also include generating 1020 a graphical user interface (GUI) on a display device. The display device may be coupled with a touch screen input that connects to a processor to perform and execute these operations 1000. The display device may receive an input that corresponds to a wager.

The input may comprise one or more wager inputs, such as a first wager input and a second wager input that corresponds to the wager data.

Operations of a casino/sports-betting gaming system may also include receiving 1030 the first wager input that selects a wager team, a wager line, and a wager odds from the wager data. The first wager input may be received via the GUI. The wager team may include a team participating in the event. The wager line may include: point spread, game totals (i.e. over/unders), team totals, player props, or any other bet type that is offered. Operations of a casino/sports-betting gaming system may also include receiving 1040 the second wager input that selects a wagering amount. The second wager input may be received via the GUI.

Operations of a casino/sports-betting gaming system may include receiving 1050 an odds booster input that corresponds to an odds booster game for the wager team, the wager line, the wager odds, and the wager amount. The odds booster game may change or adjust the wager line and the wagers odds. The odds booster game may include a random number generator operating within a machine learning algorithm executing within the processor.

The odds booster game may include one or more of a line adjustment graphic and an odds adjustment graphic.

Operations of a casino/sports-betting gaming system may include generating 1060 the line adjustment graphic on the GUI. The random number generator operating within the machine learning algorithm executing within the processor may generate the line adjustment graphic. The line adjustment graphic may include a line differential wheel that includes a plurality of line adjustments as calculated by the random number generator operating within the machine learning algorithm executing within the processor. The plurality of line adjustments may include both one or more positive line adjustments and one or more negative line adjustments.

Operations of a casino/sports-betting gaming system may include calculating and adjusting 1070 an adjusted wager line using the line adjustment graphic. The random number generator operating within the machine learning algorithm executing within the processor may calculate and adjust the adjusted wager line.

Operations of a casino/sports-betting gaming system may include generating 1080 the odds adjustment graphic on the GUI. The random number generator operating within the machine learning algorithm executing within the processor may generate the odds adjustment graphic. The odds adjustment graphic may include an odds wheel that includes a plurality of odds adjustments as calculated by the random number generator operating within the machine learning algorithm executing within the processor. The plurality of odds adjustments may include both one or more positive odds adjustments and one or more negative odds adjustments.

Operations of a casino/sports-betting gaming system may include calculating and adjusting 1090 an adjusted wager odds using the odds adjustment graphic. The random number generator operating within the machine learning algorithm executing within the processor may calculate and adjust the adjusted wager odds.

Operations of a casino/sports-betting gaming system may include displaying 1100 final wager data on the GUI. The final wager data may include the wager team, the adjusted wager line, the adjusted wager odds, and the wagering amount.

Operations of a casino/sports-betting gaming system may include sending 1110 the final wager data via a communication interface to the data storage device. The final wager data may correspond to and include the wager team, the adjusted wager line, the adjusted wager odds, and the wagering amount.

The machine learning algorithm and/or random number generator 102 (WagerWheel) used for sports betting game and executing on a casino/sports-betting gaming system 100, 500, 600, 700, 800 is a multi-tier product which will resolve many issues that sportsbook operators face when dealing with: 1) acquisition—new users; 2) bonuses and promotions for both new and existing users; 3) retention of both new and existing users (not losing wallet to other sportsbook operators); and 4) reactivation of existing users.

The casino/sports-betting gaming system 100, 500, 600, 700, 800 according these embodiments will offer guests the chance at odds the users will not be able to find at any other sportsbook. Since this the casino/sports-betting gaming system 100, 500, 600, 700, 800 and the machine learning algorithm and/or random number generator 102 used for sports betting game and executing on a casino/sports-betting gaming system can be used on events before they occur, the casino/sports-betting gaming system 100, 500, 600, 700, 800 may make money off spins before any events are resolved. The casino/sports-betting gaming system 100, 500, 600, 700, 800 and the machine learning algorithm and/or random number generator 102 may be used for sports betting game and executing on a casino/sports-betting gaming system can be used for free-spin promotions for new and existing users. Overall, the casino/sports-betting gaming system 100, 500, 600, 700, 800 and the machine learning algorithm and/or random number generator 102 will benefit both the user/guest by offering enticing odds all the time that can be used on any event, for any bet type.

Additionally, the casino/sports-betting gaming system 100, 500, 600, 700, 800 and the machine learning algorithm and/or random number generator 102 will benefit the sportsbook operator by: 1) low-cost promotions; 2) acquiring guests; 3) retaining guests; 4) reactivating guests; and adding volatility to sports betting.

Further, the casino/sports-betting gaming system 100, 500, 600, 700, 800 and the machine learning algorithm and/or random number generator 102 may provide many benefits and solve problems identified by offering a new and innovative betting experience. The casino/sports-betting gaming system 100, 500, 600, 700, 800 and the machine learning algorithm and/or random number generator 102 may offer a new thrilling element to sports betting, adding volatility and unpredictability for the better/user. The casino/sports-betting gaming system 100, 500, 600, 700, 800 and the machine learning algorithm and/or random number generator 102 may offer a bettor/user jackpot-style odds on a very popular bet, such as propositions and/or straight bets. The casino/sports-betting gaming system 100, 500, 600, 700, 800 and the machine learning algorithm and/or random number generator 102 may diversify betting options by offering a wager before the wager. The casino/sports-betting gaming system 100, 500, 600, 700, 800 and the machine learning algorithm and/or random number generator 102 may bring new users to the casino/sportsbook and helps with migration of bettors/users from competitors. The casino/sports-betting gaming system 100, 500, 600, 700, 800 and the machine learning algorithm and/or random number generator 102 may be used as a promotional tool to promote marquee games. The casino/sports-betting gaming system 100, 500, 600, 700, 800 and the machine learning algorithm and/or random number generator 102 may be used for retention and reactivation of bettors/users by giving the bettors/users an experience that is unique. The casino/sports-betting gaming system 100, 500, 600, 700, 800 and the machine learning algorithm and/or random number generator 102 may provide a revenue boost and can lead to increased revenue as the game entices users to take a chance at odds they would not be able to find at traditional sportsbooks. The casino/sports-betting gaming system 100, 500, 600, 700, 800 and the machine learning algorithm and/or random number generator 102 can drive more bettor/user visits into the casino and/or generator more revenue for the casino/sportsbook building as compared to the bettor betting from mobile at home.

The casino/sports-betting gaming system 100, 500, 600, 700, 800 and the machine learning algorithm and/or random number generator 102 can be used in land-based casinos, such as being integrated into kiosks which would enhance the gaming experience for bettors/users. The casino/sports-betting gaming system 100, 500, 600, 700, 800 and the machine learning algorithm and/or random number generator 102 may also be used in online casinos/mobile sportsbooks.

As will be appreciated by one skilled in the art, aspects of the present disclosure and the casino/sports-betting gaming system and the machine learning algorithm and/or random number generator may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks. The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the foregoing specification, the present disclosure has been described with reference to specific exemplary embodiments thereof. Although the disclosure has been described in terms of a preferred embodiment, those skilled in the art will recognize that various modifications, embodiments or variations of the disclosure can be practiced within the spirit and scope of the disclosure as set forth in the appended claims. The specification and drawings are, therefore, to be regarded in an illustrated rather than restrictive sense. Accordingly, it is not intended that the disclosure be limited except as may be necessary in view of the appended claims.

We claim:

1. An online gaming platform using dynamic content and real-time personalization, the online gaming platform comprising:
a display device for displaying the dynamic content, wherein the dynamic content is associated with an opportunity to input wagers related to one or more live sporting events;
a touch screen input;
a processor coupled to the display device and the touch screen input; and
a memory coupled to the processor, the memory comprising machine-readable instructions that, when executed by the processor, cause the processor to:
receive, by a video controller, the dynamic content;
retrieve, from a data storage device, wager data corresponding to the one or more live sporting events, betting lines, and wagers;
cause display, on the display device, the wager data associated with the opportunity to input wagers related to the one or more live sporting events;
receive, based on the opportunity to input wagers, from a graphical user interface (GUI) on the display device, and associated with a user, a first wager input and a second wager input corresponding to the one or more live sporting events, wherein the first wager input includes a selection of a wager team, a wager line, and a wager odds from the wager data, and the second wager input includes a wagering amount;
after receiving the first wager input and the second wager input, receive, from the GUI, a selection of an odds booster game, wherein the odds booster game changes the wager line and the wager odds;
cause, on the GUI of the display device, display of a graphic representation of a first spinning wheel comprising a plurality of line adjustments;
in response to a first user input to spin the first spinning wheel, generate, via a random number generator implementing a machine learning algorithm, an adjusted wager line, wherein the machine learning algorithm comprises a semi-supervised learning mechanism;
cause, on the GUI of the display device, display of the first spinning wheel indicating a selection of the adjusted wager line;
cause, on the GUI of the display device, display of a graphic representation of a second spinning wheel comprising a plurality of odds adjustments;
monitor, via the GUI of the display device, information on live user interactions with the first spinning wheel and the second spinning wheel;
provide, as input to the machine learning algorithm, historical weighting betting and odds booster information associated with the user and the information on the live user interactions;
receive, as output from the machine learning algorithm, favorable odds that increase the user's potential winnings, or challenging odds that add an element of risk and unpredictability, wherein the favorable odds or the challenging odds are tailored for the user based on the dynamic content and the live user interactions;
in response to a second user input to spin the second spinning wheel, generate, via the random number generator and in real time, an adjusted wager odds comprising the favorable odds or the challenging odds;
cause, on the GUI of the display device, display of the second spinning wheel indicating a selection of the adjusted wager odds;
cause, on a final result screen of the GUI, display of final wager data that includes the wager team, the adjusted wager line, the adjusted wager odds, and the wagering amount; and
send, via a communication interface and to the data storage device, the final wager data comprising the wager team, the adjusted wager line, the adjusted wager odds, and the wagering amount.

2. The online gaming platform of claim 1, wherein the first spinning wheel comprises a line differential wheel that includes the plurality of line adjustments to the wager line as calculated using random line adjustment numbers generated by the random number generator executing within the processor.

3. The online gaming platform of claim 2, wherein the plurality of line adjustments to the wager line includes one or more positive line adjustments to the wager line and one or more negative line adjustments to the wager line.

4. The online gaming platform of claim 1, wherein the second spinning wheel comprises an odds wheel that includes the plurality of odds adjustments to the wager odds as calculated using random odds adjustment numbers generated by the random number generator executing within the processor.

5. The online gaming platform of claim 1, wherein the wager data comprises a home/away indication and event time/date information.

6. The online gaming platform of claim 1, wherein the display device, the touch screen input, and the processor are included within a mobile device.

7. The online gaming platform of claim 1 further including a gaming terminal with a housing that encloses the display device, the touch screen input, and the processor.

8. A computer-implemented method for an online gaming platform using dynamic content and real-time personalization, the method comprising:
receiving, by a video controller, the dynamic content, wherein the dynamic content is associated with an opportunity to input wagers related to one or more live sporting events;
retrieving, by a computing device and from a data storage device, wager data corresponding to the one or more live sporting events, betting lines, and wagers;
causing display, on a display device, the dynamic content and the wager data associated with the opportunity to input wagers related to the one or more live sporting events;
receiving, based on the opportunity to input wagers, by the computing device and from a graphical user interface (GUI) on the display device associated with a user a first wager input and a second wager input corresponding to the one or more live sporting events;
wherein the first wager input comprises a selection of a wager team, a wager line, and a wager odds from the wager data, and the second wager input comprises a wagering amount;
after receiving the first and second wager input, receiving, by the computing device and from the GUI, a selection of an odds booster game, wherein the odds booster game changes the wager line and the wager odds;
causing, by the computing device and on the GUI of the display device, display of a graphic representation of a first spinning wheel comprising a plurality of line adjustments;
in response to a first user input to spin the first spinning wheel, generating, by the computing device and via a random number generator implementing a machine learning algorithm executing within a processor, an adjusted wager line comprising favorable odds or challenging odds, wherein the machine learning algorithm comprises a semi-supervised learning mechanism;
causing, by the computing device and on the GUI of the display device, display of the first spinning wheel indicating a selection of the adjusted wager line;
causing, by the computing device and on the GUI of the display device, display of a graphic representation of a second spinning wheel comprising a plurality of odds adjustments;
monitoring, via the GUI of the display device, information on liver user interactions with the first spinning wheel and the second spinning wheel;
providing, as input to the machine learning algorithm, historical weighting betting and odds booster information associated with the user and the information on the live user interactions;
receiving, as output from the machine learning algorithm, favorable odds that increase a user's potential winnings, or challenging odds that add an element of risk and unpredictability, wherein the favorable odds or the challenging odds are tailored for the user based on the dynamic content and the live user interactions;
in response to a second user input to spin the second spinning wheel, generating, by the computing device and via the random number generator in real time, an adjusted wager odds comprising the favorable odds or the challenging odds;
causing, by the computing device and on the GUI of the display device, display of the second spinning wheel indicating a selection of the adjusted wager odds;
causing, by the computing device and via the GUI, display of a final result screen comprising final wager data, wherein the final wager data comprises the wager team, the adjusted wager line, the adjusted wager odds, and the wagering amount; and
sending, by the computing device and to the data storage device, the final wager data comprising the wager team, the adjusted wager line, the adjusted wager odds, and the wagering amount.

9. The method of claim 8, wherein the first spinning wheel comprise a line differential wheel that includes the plurality of line adjustments to the wager line as calculated using random number line adjustment numbers generated by the random number generator implementing the machine learning algorithm.

10. The method of claim 9, wherein the plurality of line adjustments to the wager line includes one or more positive line adjustments to the wager line and one or more negative line adjustments to the wager line.

11. The method of claim 8, wherein the second spinning wheel comprises an odds wheel that includes the plurality of odds adjustments to the wager odds as calculated using random odds adjustment numbers generated by the random number generator implementing the machine learning algorithm.

12. The method of claim 8, wherein the wager data comprises a home/away indication and event time/date information.

13. The method of claim 8, wherein the display device and the processor are included within a mobile device.

14. The method of claim 8, wherein the display device and the processor are included a gaming terminal with a housing that encloses the display device and the processor.

15. The method of claim 8, further comprising:
training the machine learning algorithm implemented on the random number generator based on real-time user interaction with the first and second spinning wheels; and
using the trained machine learning algorithm to recalibrate the adjusted wager odds in real-time.

16. The method of claim 8, wherein the machine learning algorithm implemented on the random number generator learns trends and improves analyzing, calculating, identifying, and weighting the adjusted wager odds from historical determinations.

17. A system for an online gaming platform using dynamic content and real-time personalization, the system comprising:
a processor; and
a memory coupled to the processor, the memory comprising machine-readable instructions that, when executed by the processor, cause the processor to:
receive, by a video controller, the dynamic content;
retrieve, from a data storage device, wager data corresponding to one or more live sporting events, betting lines, and wagers;
cause display, on a display device, the dynamic content and the wager data associated with an opportunity to input wagers related to the one or more live sporting events;
receive, based on the opportunity to input waters, from a graphical user interface (GUI) on a display device, and associated with a user, a first wager input and a second wager input corresponding to the wager data,
wherein the first wager input includes a selection of a wager team, a wager line, and a wager odds from the wager data, and
the second wager input includes a wagering amount;
after receiving the first wager input and the second wager input, receive, from the GUI, a selection of an odds booster game, wherein the odds booster game changes the wager line and the wager odds;
cause, on the GUI of the display device, display of a graphic representation of a first spinning wheel comprising a plurality of line adjustments;
in response to a first user input to spin the first spinning wheel, generate, via a random number generator implementing a machine learning algorithm, an adjusted wager line, wherein the machine learning algorithm comprises a semi-supervised learning mechanism;
cause, on the GUI of the display device, display of the first spinning wheel indicating a selection of the adjusted wager line;
cause, on the GUI of the display device, display of a graphic representation of a second spinning wheel comprising a plurality of odds adjustment;
monitor, via the GUI of the display device, information on live user interactions with the first spinning wheel and the second spinning wheel;
provide, as input to the machine learning algorithm, historical weighting betting and odds booster information associated with the user and the information on the live user interactions;
receive, as output from the machine learning algorithm, favorable odds that increase a user's potential winnings, or challenging odds that add an element of risk and unpredictability, wherein the favorable odds or the challenging odds are tailored for the user based on the dynamic content and the live user interactions;
in response to a second user input to spin the second spinning wheel, generate, via the random number generator in real time an adjusted wager odds comprising the favorable odds or the challenging odds;
cause, on the GUI of the display device, display of the second spinning wheel indicating a selection of the adjusted wager odds;
cause, on a final result screen of the GUI, final wager data that includes the wager team, the adjusted wager line, the adjusted wager odds, and the wagering amount; and
send, via a communication interface and to the data storage device, the final wager data comprising the wager team, the adjusted wager line, the adjusted wager odds, and the wagering amount.

18. The system of claim 17 further including a mobile device that includes the processor and the memory.

19. The system of claim 17 further including a gaming terminal with a housing that encloses the processor and the memory.

20. The system of claim 17, wherein the first spinning wheel comprises a line differential wheel that includes the plurality of line adjustments to the wager line as calculated using random line adjustment numbers generated by the random number generator implementing the machine learning algorithm executing within the processor, and wherein the plurality of line adjustments to the wager line includes one or more positive line adjustments to the wager line and one or more negative line adjustments to the wager line; and further wherein the second spinning wheel comprises an odds wheel that includes the plurality of odds adjustments to the wager odds as calculated using random odds adjustment numbers generated by the random number generator implementing the machine learning algorithm executing within the processor.
